(19) United States
(12) Patent Application Publication
(10) Pub. No.: US 2021/0108109 A1
(43) Pub. Date: Apr. 15, 2021

(54) POLARIZING FILM WITH ADDED ADHESIVE LAYER, POLARIZING FILM WITH ADDED ADHESIVE LAYER FOR IN-CELL LIQUID CRYSTAL PANEL, IN-CELL LIQUID CRYSTAL PANEL, AND LIQUID CRYSTAL DISPLAY DEVICE

(71) Applicant: NITTO DENKO CORPORATION, Ibaraki-shi, Osaka (JP)

(72) Inventors: Masakuni Fujita, Ibaraki-shi (JP); Satoshi Yamamoto, Ibaraki-shi (JP); Yusuke Toyama, Ibaraki-shi (JP)

(73) Assignee: NITTO DENKO CORPORATION, Ibaraki-shi, Osaka (JP)

(21) Appl. No.: 16/498,745

(22) PCT Filed: Mar. 28, 2018
(86) PCT No.: PCT/JP2018/012625

§ 371 Date: Sep. 27, 2019

(30) Foreign Application Priority Data
Mar. 28, 2017 (JP) 2017-063997

(51) Int. Cl. C09J 9/02; G02F 1/1333; G02F 1/1335; G02F 1/1337; C09J 7/38; C09J 5/00; G06F 3/041

(52) U.S. Cl. CPC C09J 9/02; G02F 1/13338; G02F 1/133528; G02F 1/133738; C09J 7/385; C09J 5/00; G06F 3/0445; G02F 2202/28; G02F 2201/50; G02F 2202/22; C09J 2203/318; C09J 2433/00; G06F 3/0412

(57) ABSTRACT

An in-cell type liquid crystal panel is disclosed containing an in-cell type liquid crystal cell, a first polarizing film disposed on a viewing side of the in-cell liquid crystal cell, a second polarizing film disposed opposite to the viewing side, and a first pressure-sensitive adhesive layer disposed between the first polarizing film and the in-cell type liquid crystal cell, wherein: a surface resistance value of the first pressure-sensitive adhesive layer side is 1.0×10⁸ to 1.0×10¹¹Ω/□ at the time of producing a first pressure-sensitive adhesive layer attached polarizing film in a state where the first pressure-sensitive adhesive layer is provided on the first polarizing film and a separator is provided on the first pressure-sensitive adhesive layer, and peeling off the separator immediately after the production, and a moisture permeability of the transparent protective film at 40° C.×92% RH is 900 g/(m²·24 h) or less.

### TECHNICAL FIELD

The present invention relates to a pressure-sensitive adhesive layer attached polarizing film, a pressure-sensitive adhesive layer attached polarizing film for an in-cell type liquid crystal panel, an in-cell type liquid crystal panel comprising an in-cell type liquid crystal cell incorporating a touch sensing function inside the liquid crystal cell and a pressure-sensitive adhesive layer attached polarizing film on a viewing side of the in-cell type liquid crystal cell. Further, the present invention relates to a liquid crystal display device using the liquid crystal panel. The liquid crystal display device provided with a touch sensing function using the in-cell type liquid crystal panel according to the present invention can be used as various input display devices for mobile devices and the like.

### BACKGROUND ART

Generally, in liquid crystal display devices, polarizing films are bonded to both surfaces of a liquid crystal cell with a pressure-sensitive adhesive layer interposed therebetween from the viewpoint of image forming system. In addition, ones that mount a touch panel on a display screen of a liquid crystal display device have been put to practical use. As the touch panel, there are various methods such as an electrostatic capacitance type, a resistive film type, an optical type, an ultrasonic type, an electromagnetic induction type and the like, but an electrostatic capacitance type is increasingly adopted. In recent years, a liquid crystal display device provided with a touch sensing function that incorporates an electrostatic capacitance sensor as a touch sensor unit is used.

On the other hand, at the time of manufacturing a liquid crystal display device, when attaching the pressure-sensitive adhesive layer attached polarizing film to a liquid crystal cell, a release film is peeled from the pressure-sensitive adhesive layer of the pressure-sensitive adhesive layer attached polarizing film, and static electricity is generated by such peeling. Static electricity is also generated when a surface protective film of the polarizing film stuck to the liquid crystal cell is peeled off or when a surface protective film of a cover window is peeled off. The static electricity generated in this way affects the alignment of the liquid crystal layer inside the liquid crystal display device, resulting in causing defects. Generation of static electricity can be suppressed, for example, by forming an antistatic layer on the outer surface of the polarizing film.

On the other hand, the electrostatic capacitance sensor in the liquid crystal display device provided with a touch sensing function detects a weak electrostatic capacitance formed by the transparent electrode pattern and the finger when the user's finger approaches the surface. In the case where a conductive layer such as an antistatic layer is provided between the transparent electrode pattern and the user's finger, the electric field between the driving electrode and the sensor electrode is disturbed, the sensor electrode capacitance becomes unstable and the touch panel sensitivity decreases, causing malfunction. In the liquid crystal display device provided with a touch sensing function, it is required to suppress the occurrence of static electricity and suppress the malfunction of the electrostatic capacitance sensor. For example, in order to reduce the occurrence of display defects and malfunctions in a liquid crystal display device provided with a touch sensing function for the purpose of solving the above-mentioned problems, it has been proposed to dispose a polarizing film comprising an antistatic layer with a surface resistance value of 1.0×10⁹ to 1.0×10¹¹Ω/□ on the viewing side of the liquid crystal layer (Patent Document 1).

### PRIOR ART DOCUMENTS

### Patent Document

Patent Document 1: JP-A-2013-105154

### SUMMARY OF THE INVENTION

### Problems to be Solved by the Invention

According to the polarizing film comprising an antistatic layer described in Patent Document 1, generation of static electricity can be suppressed to some extent. However, in Patent Document 1, since the placement position of the antistatic layer is farther than the fundamental position of the liquid crystal cell causing the display defect due to static electricity, this case is not effective compared with the case where the antistatic function is imparted to the pressure sensitive adhesive layer. Further, it was found that the in-cell type liquid crystal cell is more easily charged than the so-called on-cell type liquid crystal cell comprising a sensor electrode on a transparent substrate of the liquid crystal cell described in Patent Document 1. In addition, in a liquid crystal display device provided with a touch sensing function using an in-cell type liquid crystal cell, it was found that conduction from the side can be imparted by providing a conduction structure on the side surface of the polarizing film, but when the antistatic layer is thin, the contact area with the conduction structure on the side surface is small, so that sufficient conductivity cannot be obtained and conduction failure occurs. On the other hand, it was found that the sensitivity of the touch sensor decreases as the thickness of the antistatic layer increases.

In addition, the pressure-sensitive adhesive layer to which the antistatic function is imparted is effective for suppressing generation of static electricity and preventing static electricity unevenness more than the antistatic layer provided on the polarizing film. However, it was found that when the conductive function of the pressure-sensitive adhesive layer is enhanced with importance placed on the antistatic function of the pressure-sensitive adhesive layer, the touch sensor sensitivity is lowered. In particular, it was found that the touch sensor sensitivity is lowered in the liquid crystal display device provided with the touch sensing function using the in-cell type liquid crystal cell. Further, it was found that the antistatic agent blended in the pressure-sensitive adhesive layer for enhancing the conductivity function segregates at the interface with the polarizing film under humidified conditions (after a humidification reliability test) or moves into the polarizing film, so that the surface resistance value on the pressure-sensitive adhesive layer side was increased, and the antistatic function was remarkably deteriorated. In particular, it was found that the polarizing film using a transparent protective film having a high moisture permeability has a large fluctuation under the humidified environment. It was revealed that such a variation in the surface resistance value on the pressure-sensitive adhesive layer side is a cause of generation of static electricity unevenness and malfunction of the liquid crystal display device provided with a touch sensing function.

Further, it is indispensable for a liquid crystal display device or the like to dispose polarizers on both sides of a liquid crystal cell from the viewpoint of the image forming method, and in general, a polarizing film is attached. As the polarizing film, one comprising a transparent protective film on one side or both sides of the polarizer is used. As the transparent protective film, for example, a cellulose resin film using triacetyl cellulose or the like is used. In addition, as the polarizer, an iodine type polarizer having a stretched structure in which iodine is adsorbed on, for example, a polyvinyl alcohol is widely used since such a polarizer has a high transmittance and a high degree of polarization. However, such a polarizer tends to shrink and expand due to moisture or the like. A polarizing film using a transparent protective film having a high moisture permeability, such as the cellulose resin film, used as such a polarizer, has a problem that the durability in a humidified environment is lowered and the degree of polarization tends to decrease.

Accordingly, an object of the present invention is to provide a pressure-sensitive adhesive layer attached polarizing film; an in-cell type liquid crystal cell and a pressure-sensitive adhesive layer attached polarizing film to be applied on the viewing side of the in-cell type liquid crystal cell for an in-cell type liquid crystal panel; and an in-cell type liquid crystal panel comprising the pressure-sensitive adhesive layer attached polarizing film; said in-cell type liquid crystal panel being excellent in antistatic function even under a humidified environment (after humidification reliability test), able to suppress static electricity unevenness, able to satisfy a touch sensor sensitivity, and also having excellent heat resistance. Another object of the present invention is to provide a liquid crystal display device using the in-cell type liquid crystal panel.

### Means for Solving the Problems

As a result of extensive studies to solve the problems, the present inventors have found that the problems can be solved by the following in-cell type liquid crystal panel and have completed the present invention.

That is, a pressure-sensitive adhesive layer attached polarizing film according to the present invention is the pressure-sensitive adhesive layer attached polarizing film, comprising a pressure-sensitive adhesive layer and a polarizing film, wherein the polarizing film includes at least a polarizer and a transparent protective film;

at least the polarizing film and the pressure-sensitive adhesive layer are provided in this order from a viewing side;

the pressure-sensitive adhesive layer includes an antistatic agent;

a surface resistance value of the pressure-sensitive adhesive layer side is 1.0×10⁸ to 1.0×10¹¹Ω/□ at the time of producing the pressure-sensitive adhesive layer attached polarizing film in a state where the pressure-sensitive adhesive layer is provided on the polarizing film and a separator is provided on the pressure-sensitive adhesive layer, and peeling off the separator immediately after the production; and

a moisture permeability of the transparent protective film at 40° C.×92% RH is 900 g/(m²·24 h) or less.

In the pressure-sensitive adhesive layer attached polarizing film according to the present invention, it is preferable that the antistatic agent be an ionic compound containing a fluorine-containing anion.

In the pressure-sensitive adhesive layer attached polarizing film according to the present invention, it is preferable that the surface resistance value on the pressure-sensitive adhesive layer side be 1.0×10⁸ to 2.0×10¹⁰Ω/□, and the moisture permeability of the transparent protective film at 40° C.×92% RH be 100 g/(m²·24 h) or less.

In the pressure-sensitive adhesive layer attached polarizing film according to the present invention, it is preferable that the moisture permeability of the transparent protective film at 40° C.×92% RH be 10 g/(m²·24 h) or more.

Also, it is preferable that a pressure-sensitive adhesive layer attached polarizing film for an in-cell type liquid crystal panel according to the present invention be a pressure-sensitive adhesive layer attached polarizing film, which is used for an in-cell type liquid crystal panel comprising an in-cell type liquid crystal cell including a liquid crystal layer containing liquid crystal molecules homogeneously aligned in the absence of an electric field, a first transparent substrate and a second transparent substrate sandwiching the liquid crystal layer from both surfaces, and a touch sensor and a touch sensing electrode unit relating to a touch driving function being provided between the first transparent substrate and the second transparent substrate, wherein:

the pressure-sensitive adhesive layer attached polarizing film is disposed on a viewing side of the in-cell type liquid crystal cell,

a pressure-sensitive adhesive layer of the pressure-sensitive adhesive layer attached polarizing film is disposed between a polarizing film of the pressure-sensitive adhesive layer attached polarizing film and the in-cell type liquid crystal cell,

the polarizing film includes at least a polarizer and a transparent protective film,

at least the polarizing film and the pressure-sensitive adhesive layer are provided in this order from the viewing side,

the pressure-sensitive adhesive layer includes an antistatic agent,

a surface resistance value of the pressure-sensitive adhesive layer side is 1.0×10⁸ to 1.0×10¹¹Ω/□ at the time of producing the pressure-sensitive adhesive layer attached polarizing film in a state where the pressure-sensitive adhesive layer is provided on the polarizing film and a separator is provided on the pressure-sensitive adhesive layer, and peeling off the separator immediately after the production, and

a moisture permeability of the transparent protective film at 40° C.×92% RH is 900 g/(m²·24 h) or less.

In the pressure-sensitive adhesive layer attached polarizing film for an in-cell type liquid crystal panel according to the present invention, it is preferable that the antistatic agent is an ionic compound containing a fluorine-containing anion.

In the pressure-sensitive adhesive layer attached polarizing film for an in-cell type liquid crystal panel according to the present invention, it is preferable that the surface resistance value on the pressure-sensitive adhesive layer side is 1.0×10⁸ to 2.0×10¹⁰Ω/□, and the moisture permeability of the transparent protective film at 40° C.×92% RH is 100 g/(m²·24 h) or less.

In the pressure-sensitive adhesive layer attached polarizing film for an in-cell type liquid crystal panel according to the present invention, it is preferable that the moisture permeability of the transparent protective film at 40° C.×92% RH is 10 g/(m²·24 h) or more.

Further, the in-cell type liquid crystal panel according to the present invention is characterized by comprising:

an in-cell type liquid crystal cell including a liquid crystal layer containing liquid crystal molecules homogeneously aligned in the absence of an electric field, a first transparent substrate and a second transparent substrate sandwiching the liquid crystal layer from both surfaces, and a touch sensing electrode unit for a touch sensor and a touch driving function between the first transparent substrate and the second transparent substrate, and

a first polarizing film disposed on a viewing side of the in-cell liquid crystal cell, a second polarizing film disposed on a side opposite to the viewing side, and a first pressure-sensitive adhesive layer disposed between the first polarizing film and the in-cell type liquid crystal cell,

wherein:

the first polarizing film includes at least a polarizer and a transparent protective film,

at least the first polarizing film and the first pressure-sensitive adhesive layer are provided in this order from the viewing side,

the pressure-sensitive adhesive layer includes an antistatic agent,

a surface resistance value of the first pressure-sensitive adhesive layer side is 1.0×10⁸ to 1.0×10¹¹Ω/□ at the time of producing a first pressure-sensitive adhesive layer attached polarizing film in a state where the first pressure-sensitive adhesive layer is provided on the first polarizing film and a separator is provided on the first pressure-sensitive adhesive layer, and peeling off the separator immediately after the production, and

a moisture permeability of the transparent protective film at 40° C.×92% RH is 900 g/(m²·24 h) or less.

In the in-cell type liquid crystal panel according to the present invention, it is preferable that the antistatic agent be an ionic compound containing a fluorine-containing anion.

In the in-cell type liquid crystal panel according to the present invention, it is preferable that the surface resistance value of the first pressure-sensitive adhesive layer side is 1.0×10⁸ to 2.0×10¹⁰Ω/□, and the moisture permeability of the transparent protective film at 40° C.×92% RH is 100 g/(m²·24 h) or less.

In the in-cell type liquid crystal panel according to the present invention, it is preferable that the moisture permeability of the transparent protective film at 40° C.×92% RH be 10 g/(m²·24 h) or more.

In addition, it is preferable that the liquid crystal display device according to the present invention comprises the in-cell type liquid crystal panel.

### Effect of the Invention

The pressure-sensitive adhesive layer attached polarizing film on the viewing side in the in-cell type liquid crystal panel of the present invention contains an antistatic agent in the pressure-sensitive adhesive layer and is given an antistatic function. Therefore, in the in-cell type liquid crystal panel, when a conduction structure is provided on each side surface of the pressure-sensitive adhesive layer or the like, the pressure-sensitive adhesive layer or the like can come in contact with the conduction structure and a sufficient contact area can be secured. As such, conduction is ensured at the side surface of each layer of the pressure-sensitive adhesive layer, making it possible to suppress the occurrence of static electricity unevenness due to poor conduction.

Further, in the pressure-sensitive adhesive layer attached polarizing film of the present invention, the surface resistance value on the pressure-sensitive adhesive layer side is controlled within a predetermined range and the transparent protective film forming the polarizing film has a moisture permeability in a specific range. Thus, the pressure-sensitive adhesive layer attached polarizing film according to the present invention is excellent in heat resistance and can satisfy the touch sensor sensitivity while stably providing a favorable antistatic function even in a humidified environment (after a humidification test).

### BRIEF DESCRIPTION OF THE DRAWINGS

FIG. 1 is a cross-sectional view showing an example of a pressure-sensitive adhesive layer attached polarizing film to be used on a viewing side of an in-cell type liquid crystal panel of the present invention.

FIG. 2 is a cross-sectional view showing an example of an in-cell type liquid crystal panel of the present invention.

FIG. 3 is a cross-sectional view showing an example of an in-cell type liquid crystal panel of the present invention.

FIG. 4 is a cross-sectional view showing an example of an in-cell type liquid crystal panel of the present invention.

FIG. 5 is a cross-sectional view showing an example of an in-cell type liquid crystal panel of the present invention.

FIG. 6 is a cross-sectional view showing an example of an in-cell type liquid crystal panel of the present invention.

### MODE FOR CARRYING OUT THE INVENTION

<Pressure-Sensitive Adhesive Layer attached Polarizing Film>

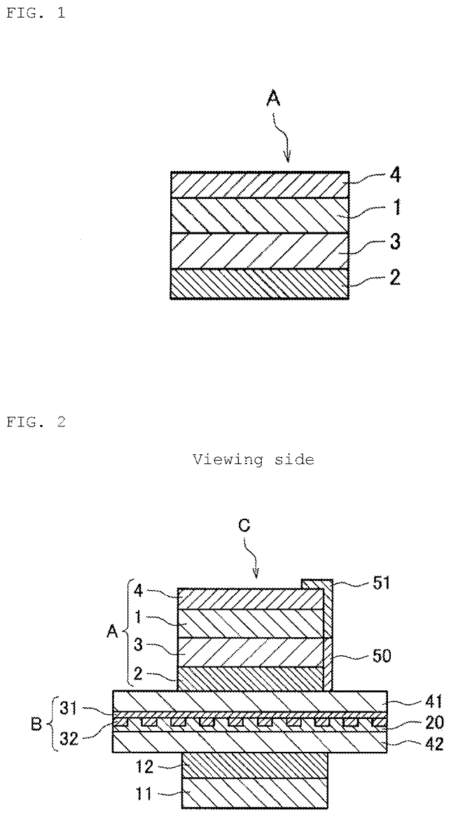

Hereinafter, the present invention will be described with reference to the drawings. As shown in FIG. 1, the pressure-sensitive adhesive layer attached polarizing film A to be used for the viewing side of the in-cell type liquid crystal panel of the present invention comprises a first polarizing film 1, an anchor layer 3, and a first pressure-sensitive adhesive layer 2 in this order (the anchor layer 3 is optionally provided). Further, a surface treatment layer 4 may be provided on the side of the first polarizing film 1 on which the anchor layer 3 is not provided. FIG. 1 illustrates a case where the pressure-sensitive adhesive layer attached polarizing film A of the present invention comprises the surface treatment layer 4. The pressure-sensitive adhesive layer attached polarizing film A is disposed on the side of a transparent substrate 41 on the viewing side of the in-cell type liquid crystal cell B shown in FIG. 2 by the pressure-sensitive adhesive layer 2. Although not shown in FIG. 1, a separator may be provided in the first pressure-sensitive adhesive layer 2 of the pressure-sensitive adhesive layer attached polarizing film A according to the present invention, and a surface protective film may be provided on the first polarizing film 1.

### <First Polarizing Film>

The first polarizing film used in the in-cell type liquid crystal panel of the present invention includes at least a polarizer and a transparent protective film and comprises at least the first polarizing film and the first pressure-sensitive adhesive layer in this order. There are cases where the polarizer is directly laminated on the first pressure-sensitive adhesive layer or laminated with the transparent protective film interposed therebetween. In addition, in general, one comprising the transparent protective film on one surface or both surfaces of the polarizer is used, and in the case where the transparent protective film is provided on one side, such case includes even a case where the transparent protective film is on the viewing side from the polarizer or a case where the transparent protective film is not on the viewing side.

The polarizer is not particularly limited, and may be a polarizer of various types. For example, the polarizer may be a product produced by a process including adsorbing a dichroic material such as iodine or a dichroic dye to a hydrophilic polymer film such as a polyvinyl alcohol-based film, a partially-formalized polyvinyl alcohol-based film, or a partially-saponified, ethylene-vinyl acetate copolymer-based film and uniaxially stretching the film, or may be a polyene-based oriented film such as a film of a dehydration product of polyvinyl alcohol or a dehydrochlorination product of polyvinyl chloride. Among these polarizers, a polarizer including a polyvinyl alcohol-based film and a dichroic material such as iodine is preferred. The thickness of these polarizers is not particularly limited but is generally about 80 μm or less.

As the polarizer, a thin polarizer having a thickness of 10 μm or less can be used. From the viewpoint of thinning, the thickness is preferably 1 to 7 μm. Such a thin type polarizer is preferable because the thickness unevenness is small, the visibility is excellent, and the dimensional change is small, resulting in excellent durability and further in that the thickness as the polarizing film can be thinned.

The moisture permeability at 40° C.×92% RH of the transparent protective film used in the in-cell type liquid crystal panel of the present invention is characterized by being 900 g/(m²·24 h) or less. Adjustment of the moisture permeability of the transparent protective film within the above range can prevent moisture from entering the pressure sensitive adhesive layer which is in contact with the transparent protective film, suppress an increase in the surface resistance value of the pressure sensitive adhesive layer, or inhibit white turbidity phenomenon. The lower the moisture permeability is, the more the surface resistance value of the pressure sensitive adhesive layer which is in contact with the transparent protective film can be suppressed from increasing. For example, it is considered that when water entering the pressure-sensitive adhesive layer circulates in a humidified environment, water volatilizes from the polarizing film side including the transparent protective film, and at that time, some of the conductive components in the pressure-sensitive adhesive layer (ionic compound) migrates to the polarizing film side, so that the conductive component on the surface of the pressure-sensitive adhesive layer which is in contact with the polarizing film decreases and the surface resistance value of the surface of the pressure-sensitive adhesive layer increases. On the other hand, if the moisture permeability of the transparent protective film forming the polarizing film is low, invasion of water into the pressure-sensitive adhesive layer can be prevented, so that an increase in the surface resistance value of the surface of the pressure-sensitive adhesive layer can be suppressed. From the viewpoint of minimizing the variation of the surface resistance value in the humidified environment, the moisture permeability is preferably 200 g/(m²·24 h) or less, more preferably 150 g/(m²·24 h) or less, even more preferably 100 g/(m²·24 h) or less, and from the viewpoint of durability, the moisture permeability is preferably 10 g/(m²·24 h) or more, more preferably 20 g/(m²·24 h) or more, even more preferably 30 g/(m²·24 h) or more. When the moisture permeability is less than 10 g/(m²·24 h), the durability under a heating environment is not sufficient and foaming and peeling of the pressure sensitive adhesive layer are likely to occur. On the other hand, when the moisture permeability exceeds 900 g/(m²·24 h), the variation in the surface resistance value in a humidified environment is large, so that compatibility between the antistatic function and the touch sensor sensitivity cannot be maintained, and durability is also insufficient, so that peeling tends to occur.

The material forming the transparent protective film used in the in-cell type liquid crystal panel of the present invention may be any material as long as it has such a moisture permeability mentioned above, but the thermoplastic resin excellent in, for example, transparency, mechanical strength, thermal stability, moisture barrier properties, isotropy and the like is used. Specific examples of such thermoplastic resins include cellulose resins (e.g. triacetyl cellulose, etc.), polyester resins, polyether sulfone resins, polysulfone resins, polycarbonate resins, polyamide resins, polyimide resins, polyolefin resins, (meth)acrylic resins, cyclic polyolefin resins (norbornene resins), polyarylate resins, polystyrene resins, polyvinyl alcohol resins, and mixtures thereof. The transparent protective film is laminated on one side of the polarizer with an adhesive layer, but on the other side, as a transparent protective film, a thermosetting resin or an ultraviolet curing resin, such as a (meth)acrylic resin, a urethane resin, an acrylic urethane resin, an epoxy resin, and a silicone resin, can be used. One or more arbitrary suitable additives may be contained in the transparent protective film. Examples of the additives include ultraviolet absorbers, antioxidants, lubricants, plasticizers, release agents, coloring inhibitors, flame retardants, nucleating agents, antistatic agents, pigments, colorants and the like. The amount of the thermoplastic resin used in the transparent protective film is preferably 50 to 100% by weight, more preferably 50 to 99% by weight, even more preferably 60 to 98% by weight, particularly preferably 70 to 97% by weight. When the content of the thermoplastic resin in the transparent protective film is 50% by weight or less, high transparency and the like originally possessed by the thermoplastic resin may not be sufficiently exhibited.

The thickness of the transparent protective film can be appropriately determined, but generally it is about 1 to 200 μm from the viewpoint of workability such as strength and handling ability, thin layer property and the like. In particular, the thickness is in the range of from 1 to 200 μm, preferably from 1 to 100 μm, more preferably from 5 to 100 μm, and is even more preferably thin in the range of from 5 to 80 μm.

The adhesive used for bonding the polarizer and the transparent protective film is not particularly limited as long as it is optically transparent, and various types such as aqueous type adhesives, solvent type adhesives, hot melt type adhesives, radical curable type adhesives, and cationic curable type adhesives are used. However, an aqueous type adhesive or a radical curable type adhesive is preferable.

### <First Pressure-Sensitive Adhesive Layer>

The first pressure-sensitive adhesive layer forming the in-cell type liquid crystal panel according to the present invention contains an antistatic agent is characterized in that a surface resistance value of the first pressure-sensitive adhesive layer side is 1.0×10⁸ to 1.0×10¹¹Ω/□ at the time of producing a first pressure-sensitive adhesive layer attached polarizing film in a state where the first pressure-sensitive adhesive layer is provided on the first polarizing film and a separator is provided on the first pressure-sensitive adhesive layer, and peeling off the separator immediately after the production.

The surface resistance value on the side of the first pressure-sensitive adhesive layer in the pressure-sensitive adhesive layer attached polarizing film is 1.0×10⁸ to 1.0×10¹¹Ω/□, preferably 1.0×10⁸ to 8.0×10¹⁰Ω/□, more preferably 2.0×10⁸ to 6.0×10¹⁰Ω/□ so as to satisfy an initial value (room temperature standing condition: 23° C.×65% RH) and an antistatic function of after humidification (for example, charging at 60° C.×95% RH for 250 hours and further standing at 40° C.×1 hour) and so as not to deteriorate the touch sensor sensitivity. The surface resistance value can be adjusted by controlling the surface resistance value of the first pressure-sensitive adhesive layer or the surface resistance value of the anchor layer when comprising a conductive anchor layer.

The thickness of the first pressure-sensitive adhesive layer is preferably from 5 to 100 μm, more preferably from 5 to 50 μm, even more preferably from 10 to 35 μm, from the viewpoint of ensuring the durability as well as the contact area with the side conduction structure.

In the in-cell type liquid crystal panel of the present invention, the variation ratio (b/a) of the surface resistance value on the first pressure-sensitive adhesive layer side is preferably 30 or less. However, the symbol “a” refers to a surface resistance value of the first pressure-sensitive adhesive layer side at the time of producing a first pressure-sensitive adhesive layer attached polarizing film in a state where the first pressure-sensitive adhesive layer is provided on the first polarizing film and a separator is provided on the first pressure-sensitive adhesive layer, and peeling off the separator immediately after the production, and the symbol “b” refers to a surface resistance value of the first pressure-sensitive adhesive layer side at the time of placing the first pressure-sensitive adhesive layer attached polarizing film in a humidified environment at 60° C.×95% RH for 120 hours and further drying the film at 40° C. for 1 hour, and peeling off the separator, respectively.

When the variation ratio (b/a) exceeds 30, the antistatic function of the pressure-sensitive adhesive layer in a humidified environment is deteriorated. The variation ratio (b/a) is preferably 30 or less, more preferably 25 or less, even more preferably 15 or less, particularly preferably from 0.4 to 10, most preferably from 0.4 to 4.

As the pressure-sensitive adhesive for forming the first pressure-sensitive adhesive layer, various pressure-sensitive adhesives can be used. Examples of the pressure-sensitive adhesives include rubber pressure-sensitive adhesives, acrylic pressure-sensitive adhesives, silicone pressure-sensitive adhesives, urethane pressure-sensitive adhesives, vinyl alkyl ether pressure-sensitive adhesives, polyvinylpyrrolidone pressure-sensitive adhesives, polyacrylamide pressure-sensitive adhesives, cellulose pressure-sensitive adhesives, and the like. A pressure-sensitive adhesive base polymer is selected depending on the type of the adhesives. Among the above-mentioned pressure-sensitive adhesives, an acrylic pressure-sensitive adhesive is preferably used from the viewpoints of excellent optical transparency, suitable adhesive properties such as wettability, cohesiveness and adhesion property, and excellent weather resistance, heat resistance and the like.

The acrylic pressure-sensitive adhesive contains a (meth)acrylic polymer as a base polymer. The (meth)acrylic polymer usually contains, as a monomer unit, an alkyl (meth)acrylate as a main component. Incidentally, (meth)acrylate refers to acrylate and/or methacrylate and the “(meth)” is used in the same meaning in this specification.

As the alkyl (meth)acrylate forming the main skeleton of the (meth)acrylic polymer, linear or branched alkyl groups each having 1 to 18 carbon atoms can be exemplified. These can be used alone or in combination. The average number of carbon atoms of these alkyl groups is preferably 3 to 9.

From the viewpoints of adhesive properties, durability, adjustment of retardation, adjustment of refractive index, and the like, an alkyl (meth)acrylate containing an aromatic ring, such as phenoxyethyl (meth)acrylate and benzyl (meth)acrylate, can be used as a copolymerization monomer.

In addition, it is preferable to use a polar functional group-containing monomer as a copolymerization monomer in order to suppress an increase in the surface resistance value over time (especially in a humidified environment) and to satisfy durability. The polar functional group-containing monomer contains any one of a carboxyl group, a hydroxyl group, a nitrogen-containing group, and an alkoxy group as a polar functional group in its structure and is also a compound containing a polymerizable unsaturated double bond such as a (meth)acryloyl group and a vinyl group.

In particular, among the polar functional group-containing monomers, the hydroxyl group-containing monomer is preferable for suppressing an increase in the surface resistance value over time (especially in a humidified environment) and satisfying the durability. These can be used singly or in combination.

Specific examples of the carboxyl group-containing monomer include (meth)acrylic acid, carboxyethyl (meth)acrylate, carboxypentyl (meth)acrylate, itaconic acid, maleic acid, fumaric acid, crotonic acid and the like.

Among the carboxyl group-containing monomers, acrylic acid is preferable from the viewpoints of copolymerizability, cost, and adhesive properties.

Specific examples of the hydroxyl group-containing monomer include hydroxyalkyl (meth)acrylates (e.g. 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, etc.), (4-hydroxymethylcyclohexyl)-methylacrylate, and the like.

Among the hydroxyl group-containing monomers, 2-hydroxyethyl (meth)acrylate and 4-hydroxybutyl (meth)acrylate are preferable from the viewpoint of compatibility between the temporal stability of the surface resistance value and durability, and 4-hydroxybutyl (meth)acrylate is particularly preferable.

Specific examples of the nitrogen-containing group-containing monomer include a nitrogen-containing heterocyclic compound having a vinyl group, such as N-vinyl-2-pyrrolidone, N-vinylcaprolactam, and N-acryloylmorpholine; dialkyl-substituted (meth)acrylamide such as N,N-dimethyl (meth)acrylamide, N,N-diethyl (meth)acrylamide, N,N-dipropyl acrylamide, N,N-diisopropyl (meth)acrylamide, N,N-dibutyl (meth)acrylamide, N-ethyl-N-methyl (meth)acrylamide, N-methyl-N-propyl (meth)acrylamide, and N-methyl-N-isopropyl (meth)acrylamide; dialkylamino (meth)acrylate such as N,N-dimethylaminomethyl (meth)acrylate, N,N-dimethylaminoethyl (meth)acrylate, N,N-dimethylaminopropyl (meth)acrylate, N,N-dimethylaminoisopropyl (meth)acrylate, N,N-dimethylaminobutyl (meth)acrylate, N-ethyl-N-methylaminoethyl (meth)acrylate, N-methyl-N-propylaminoethyl (meth)acrylate, N-methyl-N-isopropylaminoethyl (meth)acrylate, and N,N-dibutylaminoethyl (meth)acrylate; N,N-dialkyl-substituted aminopropyl (meth)acrylamides such as N,N-dimethylaminoproyl (meth)acrylamide, N,N-diethylaminoproyl (meth)acrylamide, N,N-dipropylaminoproyl (meth)acrylamide, N,N-diisopropylaminoproyl (meth)acrylamide, N-ethyl-N-methylaminopropyl (meth)acrylamide, N-methyl-N-propylaminopropyl (meth)acrylamide, N-methyl-N-isopropylaminopropyl (meth)acrylamide; and the like.

The nitrogen-containing group-containing monomer is preferable in terms of satisfying durability, and among the nitrogen-containing group-containing monomers, particularly preferred is an N-vinyl group-containing lactam monomer among nitrogen-containing heterocyclic compounds having a vinyl group.

Examples of the alkoxy group-containing monomer include 2-methoxyethyl (meth)acrylate, 2-ethoxyethyl (meth)acrylate, 2-propoxyethyl (meth)acrylate, 2-isopropoxyethyl (meth)acrylate, 2-butoxyethyl (meth)acrylate, 2-methoxypropyl (meth)acrylate, 2-ethoxypropyl (meth)acrylate, 2-propoxypropyl (meth)acrylate, 2-isopropoxypropyl (meth)acrylate, 2-butoxypropyl (meth)acrylate, 3-methoxypropyl (meth)acrylate, 3-ethoxypropyl (meth)acrylate, 3-propoxypropyl (meth)acrylate, 3-isopropoxypropyl (meth)acrylate, 3-butoxypropyl (meth)acrylate, 4-methoxybutyl (meth)acrylate, 4-ethoxybutyl (meth)acrylate, 4-propoxybutyl (meth)acrylate, 4-isopropoxybutyl (meth)acrylate, 4-butoxybutyl(meth)acrylate, and the like.

These alkoxy group-containing monomers have a structure in which the alkyl group moiety in an alkyl (meth)acrylate is substituted with an alkoxy group.

Further, examples of the copolymerizable monomers (copolymerization monomers) other than the above include a silane-based monomer containing a silicon atom. Examples of the silane-based monomer include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, 10-acryloyloxydecyltriethoxysilane, and the like.

As the copolymerization monomer, it is also possible to use a polyfunctional monomer having two or more unsaturated double bonds of a (meth)acryloyl group, a vinyl group or the like, such as an esterified substance of (meth)acrylic acid and polyalcohol, wherein the esterified substance includes: tripropylene glycol di(meth)acrylate, tetraethylene glycol di(meth)acrylate, 1,6-hexanediol di(meth)acrylate, bisphenol A diglycidyl ether di(meth)acrylate, neopentyl glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, and caprolactone-modified dipentaerythritol hexa(meth)acrylate; and polyester(meth)acrylate, epoxy(meth)acrylate and urethane(meth)acrylate obtained by adding, as the same functional group as that in the monomer component, two or more unsaturated double bonds of a (meth)acryloyl group, a vinyl group or the like, respectively, to polyester, epoxy and urethane as a backbone.

In addition, an alicyclic structure-containing monomer can be introduced into the (meth)acrylic polymer by copolymerization for the purpose of improving durability and imparting stress relaxation property. The carbon ring having an alicyclic structure in the alicyclic structure-containing monomer may have a saturated structure or may partially have an unsaturated bond. The alicyclic structure may be a monocyclic alicyclic structure or a polycyclic alicyclic structure such as a bicyclic or tricyclic structure. Examples of the alicyclic structure-containing monomer include cyclohexyl (meth)acrylate, dicyclopentanyl (meth)acrylate, adamantyl (meth)acrylate, isobornyl (meth) acrylate, dicyclopentenyl (meth) acrylate, dicyclopentenyloxyethyl (meth)acrylate, and the like. Among them, from the viewpoint of exhibiting excellent durability, dicyclopentanyl (meth)acrylate, adamantyl (meth)acrylate or isobornyl (meth)acrylate are preferable, and isobornyl (meth)acrylate is particularly preferable.

The (meth)acrylic polymer contains alkyl (meth)acrylate as a main component and the proportion thereof at the weight ratio with respect to all the constituent monomers is preferably 65 to 99.99% by weight, more preferably 70 to 99.9% by weight, even more preferably 75 to 98% by weight. By using the alkyl (meth)acrylate as a main component, excellent adhesive properties are achieved, which is preferable.

In the (meth)acrylic polymer, the weight ratio of the copolymerization monomer with respect to all the constituent monomers is preferably 0.01 to 35% by weight, more preferably 0.1 to 30% by weight, even more preferably 2 to 25% by weight.

Among these copolymerization monomers, the hydroxyl group-containing monomer and the carboxyl group-containing monomer are preferably used from the viewpoint of adhesion property and durability. Further, the hydroxyl group-containing monomer and the carboxyl group-containing monomer can be used in combination. In the case where the pressure-sensitive adhesive composition contains a crosslinking agent, these copolymerization monomers serve as a reactive site with the crosslinking agent. The hydroxyl group-containing monomer and the carboxyl group-containing monomer are sufficiently reactive with an intermolecular crosslinking agent, so that such a monomer is preferably used to enhance cohesion property and heat resistance of a resulting pressure-sensitive adhesive layer. The hydroxyl group-containing monomer is preferable from the viewpoint of reworkability, and the carboxyl group-containing monomer is preferable from the viewpoint of achieving both durability and reworkability.

In the case of containing the hydroxyl group-containing monomer as the copolymerization monomer, the content thereof is preferably 0.01 to 15% by weight, more preferably 0.02 to 10% by weight, even more preferably 0.05 to 5% by weight. Further, in the case of containing the carboxyl group-containing monomer as the copolymerization monomer, the content thereof is preferably 0.01 to 10% by weight, more preferably 0.1 to 5% by weight, even more preferably 0.2 to 2% by weight.

The (meth)acrylic polymer used in the present invention usually has a weight average molecular weight (Mw) in the range of 500,000 to 3,000,000. Considering durability, particularly, heat resistance, the weight average molecular weight is preferably 700,000 to 2,700,000, more preferably 800,000 to 2,500,000. When the weight average molecular weight is smaller than 500,000, this molecular weight is not preferable from the viewpoint of heat resistance. In addition, when the weight average molecular weight is larger than 3,000,000, a large amount of diluting solvent is necessary for adjusting the viscosity for coating, which is not preferable because the cost is increased. The weight average molecular weight is a value obtained by subjecting a measurement value from GPC (gel permeation chromatography) to a polystyrene conversion.

As regards production of the (meth)acrylic polymer, it is possible to selectively use one of conventional production methods such as solution polymerization, bulk polymerization, emulsion polymerization and various radical polymerizations, on a case-by-case basis. The resulting (meth)acrylic polymer may be any type of copolymers such as a random copolymer, a block copolymer or a graft copolymer.

### <Antistatic Agent>

The first pressure-sensitive adhesive layer forming the in-cell type liquid crystal panel of the present invention contains an antistatic agent. From the viewpoint of the antistatic function, the antistatic agent is preferably an ionic compound containing a fluorine-containing anion. The ionic compound is preferable from the viewpoints of compatibility with the base polymer and transparency of the pressure-sensitive adhesive layer. As the ionic compound, an inorganic cation-anion salt and/or an organic cation-anion salt can be preferably used. In the present invention, the “inorganic cation-anion salt” generally refers to an alkali metal salt formed from an alkali metal cation and an anion, and as the alkali metal salt, an organic salt of an alkali metal and an inorganic salt of an alkali metal can be used. Further, as used in the present invention, the “organic cation-anion salt” means an organic salt, the cation part of which is composed of an organic substance, and the anion part may be an organic substance or an inorganic substance. The “organic cation-anion salt” is also called as an ionic liquid or an ionic solid. In particular, it is a preferable embodiment to use an ionic liquid from the viewpoint that since the pressure-sensitive adhesive layer used for the in-cell type liquid crystal panel not via the conductive layer is required to have a high antistatic property, even if a large amount of the ionic liquid is added, problems such as precipitation/segregation and appearance defects such as clouding in a humidified environment hardly occur and the ionic liquid is excellent in antistatic function. Note that the ionic liquid herein used means a molten salt (an organic cation-anion salt) exhibiting a liquid state at 40° C. or less. Further, as the ionic liquid, it is particularly preferable to use one having a melting point of 25° C. or less.

### <Alkali Metal Salt>

Examples of alkali metal ions forming the cation part of the alkali metal salt include lithium, sodium, and potassium ions. Among these alkali metal ions, a lithium ion is preferable.

The anion moiety of the alkali metal salt may be composed of an organic substance or may be composed of an inorganic substance. Examples of the anion moiety forming the organic salt include CH₃COO⁻, CF₃COO⁻, CH₃SO₃⁻, CF₃SO₃⁻, (CF₃SO₂)₃C⁻, C₄F₉SO₃⁻, C₃F₇COO⁻, (CF₃SO₂) (CF₃CO)N⁻, ⁻O₃S(CF₂)₃SO₃⁻, PF₆⁻, CO₃²⁻, and the following general formulas (1) to (4):

(1): (CₙF₂ₙ₊₁SO₂)₂N⁻ (wherein n is an integer of 1 to 10),

(2): CF₂(CₘF₂ₘSO₂)₂N⁻ (wherein m is an integer of 1 to 10),

(3): ⁻O₃S(CF₂)₁SO₃⁻ (wherein l is an integer of 1 to 10),

(4): (CₚF₂ₚ₊₁SO₂)N⁻(C_{q}F_{2q+1}SO₂) (wherein p and q are each an integer of 1 to 10), and (FSO₂)₂N⁻, and the like. In particular, an anion moiety containing a fluorine atom is preferably used since such a moiety is able to give an ionic compound having a good ion dissociation property. Examples of the anion moiety forming the inorganic salt include Cl⁻, Br⁻, I⁻, AlCl₄⁻, Al₂Cl₇⁻, BF₄⁻, PF₆⁻, ClO₄−, NO₃⁻, AsF₆⁻, SbF₆⁻, NbF₆⁻, TaF₆⁻, (CN)₂N⁻, and the like. Among the fluorine atom-containing anions, fluorine-containing imide anions are preferable, and among them, bis(trifluoromethanesulfonyl)imide anion and bis(fluorosulfonyl)imide anion are preferable. The bis(fluorosulfonyl)imide anion is particularly preferable because it can impart excellent antistatic properties by adding a relatively small amount thereof, maintains the adhesive properties and is advantageous in durability in a humidified or heating environment.

Specific examples of the alkali metal organic salt include preferably sodium acetate, sodium alginate, sodium lignin sulfonate, sodium toluene sulfonate, LiCF₃SO₃, Li(CF₃SO₂)₂N, Li(CF₃SO₂)₂N, Li(C₂F₅SO₂)₂N, Li(C₄F₉SO₂)₂N, Li(CF₃SO₂)₃C, KO₃S(CF₂)₃SO₃K and LiO₃S(CF₂)₃SO₃K. Of these, LiCF₃SO₃, Li(CF₃SO₂)₂N, Li(C₂F₅SO₂)₂N, Li(C₄F₉SO₂)₂N, Li(CF₃SO₂)₃C, and the like are preferable, and fluorine-containing lithium imide salts such as Li(CF₃SO₂)₂N, Li(C₂F₅SO₂)₂N, Li(C₄F₉SO₂)₂N, and Li(FSO₂)₂N are more preferable, and bis(trifluoromethanesulfonyl)imide lithium salt and bis(fluorosulfonyl)imide lithium salt are particularly preferable.

Examples of the alkali metal inorganic salt include lithium perchlorate and lithium iodide.

### <Organic Cation Anion Salt>

The organic cation-anion salt used in the present invention is composed of a cation component and an anion component, and the cation component is composed of an organic substance. Specific examples of the cation component include a pyridinium cation, a piperidinium cation, a pyrrolidinium cation, a cation having a pyrroline skeleton, a cation having a pyrrole skeleton, an imidazolium cation, a tetrahydropyrimidinium cation, a dihydropyrimidinium cation, a pyrazolium cation, a pyrazolinium cation, a tetraalkylammonium cation, a trialkylsulfonium cation, a tetraalkylphosphonium cation, and the like.

Examples of the anion component include Cl⁻, Br⁻, I⁻, AlCl₄⁻, Al₂Cl₇⁻, BF₄⁻, PF₆⁻, ClO₄−, NO₃⁻, CH₃COO⁻, CF₃COO⁻, CH₃SO₃⁻, CF₃SO₃⁻, (CF₃SO₂)₃C⁻, AsF₆⁻, SbF₆⁻, NbF₆⁻, TaF₆⁻, (CN)₂N⁻, C₄F₉SO₃⁻, C₃F₇COO⁻, (CF₃SO₂) (CF₃CO)N⁻, ⁻O₃S(CF₂)₃SO₃⁻, and the following general formulas (1) to (4):

(1): (CₙF₂ₙ₊₁SO₂)₂N⁻ (wherein n is an integer of 1 to 10),

(2): CF₂(CₘF₂ₘSO₂)₂N⁻ (wherein m is an integer of 1 to 10),

(3): ⁻O₃S(CF₂)₁SO₃⁻(wherein l is an integer of 1 to 10),

(4): (CₚF₂ₚ₊₁SO₂)N⁻(C_{q}F_{2q+1}SO₂) (wherein p and q are each an integer of 1 to 10), and (FSO₂)₂N, and the like. Among them, an anion containing a fluorine atom (fluorine-containing anion) is particularly preferably used since an ionic compound having a good ion dissociation property can be obtained. Among the fluorine atom-containing anions, fluorine-containing imide anions are preferable, and of these, bis(trifluoromethanesulfonyl)imide anion and bis(fluorosulfonyl)imide anion are preferable. In particular, the bis(fluorosulfonyl)imide anion is preferable because such anion can impart excellent antistatic properties by adding a relatively small amount thereof and maintains the adhesive properties and is advantageous in durability in a humidified or heating environment.

In addition to the inorganic cation-anion salt (alkali metal salt) and the organic cation-anion salt, examples of the ionic compound include inorganic salts such as ammonium chloride, aluminum chloride, copper chloride, ferrous chloride, ferric chloride, ammonium sulfate and the like. These ionic compounds can be used singly or in combination.

Further, as other antistatic agents, for example, materials which can impart antistatic properties, such as ionic surfactants, conductive polymers, and conductive fine particles, can be mentioned.

Examples of the ionic surfactant include various surfactants including cationic surfactants (for example, quaternary ammonium salt type, phosphonium salt type, sulfonium salt type, etc.), anionic surfactants (carboxylic acid type, sulfonate type, sulfate type, phosphate type, phosphite type, etc.), zwitterionic surfactants (sulfobetaine type, alkylbetain type, alkylimidazolium betaine type, etc.) or nonionic surfactants (polyhydric alcohol derivative, β-cyclodextrin inclusion compound, sorbitan fatty acid monoester/diester, polyalkylene oxide derivative, amine oxide, etc.).

Examples of the conductive polymer include polymers of polyaniline type, polythiophene type, polypyrrole type, polyquinoxaline type and the like, among which polymers such as polyaniline and polythiophene that are likely to be water soluble conductive polymers or water dispersible conductive polymers are preferably used. Polythiophene is particularly preferable.

As the conductive fine particles, metal oxides such as tin oxide type, antimony oxide type, indium oxide type, zinc oxide type and the like can be mentioned. Of these, the tin oxide type is preferable. Examples of tin oxide type materials include antimony-doped tin oxide, indium-doped tin oxide, aluminum-doped tin oxide, tungsten-doped tin oxide, titanium oxide-cerium oxide-tin oxide complex, titanium oxide-tin oxide complex and the like, in addition to tin oxide. The average particle diameter of the fine particles is about 1 to 100 nm, preferably 2 to 50 nm.

Further, as other antistatic agents, there are exemplified polymers having an ion conductive group, such as a homopolymer of a monomer having an ion conductive group such as acetylene black, ketjen black, natural graphite, artificial graphite, titanium black, cation type (quaternary ammonium salt etc.), amphoteric type (betaine compound etc.), anion type (sulfonic acid salt etc.) or nonionic type (glycerin etc.), and a copolymer of the above monomer and another monomer; an ion conductive polymer having a site derived from an acrylate or a methacrylate having a quaternary ammonium base; and a permanent antistatic agent of a type in which a hydrophilic polymer such as a polyethylene methacrylate copolymer is alloyed to an acrylic resin or the like.

The amount of each of the pressure-sensitive adhesive and the antistatic agent to be used varies depending on the type thereof, but controlled so that the surface resistance value of the resulting pressure-sensitive adhesive layer attached polarizing film on the first pressure-sensitive adhesive layer side is within a range of 1.0×10⁸ to 1.0×10¹¹Ω/□. For example, the antistatic agent (for example, in the case of an ionic compound) is preferably used in an amount in the range of 0.05 to 20 parts by weight per 100 parts by weight of a base polymer of a pressure-sensitive adhesive (for example, a (meth)acrylic polymer). The use of the antistatic agent within the above range is preferable for improving the antistatic performance. On the other hand, if the amount of the antistatic agent exceeds 20 parts by weight, when the pressure-sensitive adhesive layer or the in-cell type liquid crystal panel including the pressure-sensitive adhesive layer is exposed to humidified conditions, problems such as precipitation/segregation of the antistatic agent and clouding of the pressure-sensitive adhesive layer occur, or foaming/peeling occur in a humidified environment, so that durability may not be sufficient, which is not preferable. In addition, when an anchor layer is provided, a adhesiveness (anchoring force) between the anchor layer and the pressure-sensitive adhesive layer may be lowered, which is not preferable. Further, the amount of the antistatic agent to be added is preferably 0.1 parts by weight or more, more preferably 1 part by weight or more. In order to satisfy the durability, the antistatic agent is preferably used in an amount of 18 parts by weight or less, more preferably 16 parts by weight or less.

The pressure-sensitive adhesive composition for forming the first pressure-sensitive adhesive layer can contain a crosslinking agent corresponding to the base polymer. For example, when a (meth)acrylic polymer is used as the base polymer, an organic crosslinking agent or a polyfunctional metal chelate can be used as the crosslinking agent. As the organic crosslinking agent, an isocyanate type crosslinking agent, a peroxide type crosslinking agent, an epoxy type crosslinking agent, an imine type crosslinking agent and the like can be mentioned. The polyfunctional metal chelate is a chelate in which a polyvalent metal is covalently or coordinately bonded to an organic compound. As the polyvalent metal atom, there can be mentioned, for example, Al, Cr, Zr, Co, Cu, Fe, Ni, V, Zn, In, Ca, Mg, Mn, Y, Ce, Sr, Ba, Mo, La, Sn, Ti, etc. Examples of the atom in the organic compound to be covalently or coordinately bonded include an oxygen atom and the like, and examples of the organic compound include an alkyl ester, an alcohol compound, a carboxylic acid compound, an ether compound, a ketone compound, and the like.

The amount of the crosslinking agent to be used is preferably 3 parts by weight or less, more preferably 0.01 to 3 parts by weight, even more preferably 0.02 to 2 parts by weight, particularly preferably 0.03 to 1 part by weight, per 100 parts by weight of the (meth)acrylic polymer.

The pressure-sensitive adhesive composition for forming the first pressure-sensitive adhesive layer may contain a silane coupling agent and other additives. As the other additives, for example, polyether compounds of polyalkylene glycol such as polypropylene glycol, powders such as colorants and pigments, dyes, surfactants, plasticizers, tackifiers, surface lubricants, leveling agents, softeners, antioxidants, anti-aging agents, light stabilizers, ultraviolet absorbers, polymerization inhibitors, inorganic or organic fillers, metal powder, particulates, foil-like materials, and the like. In addition, a redox system in which a reducing agent is added may be adopted within a controllable range. These additives are preferably used in an amount of not more than 5 parts by weight, more preferably not more than 3 parts by weight, even more preferably not more than 1 part by weight, with respect to 100 parts by weight of the (meth)acrylic polymer.

### <Anchor Layer>

When the in-cell type liquid crystal panel of the present invention comprises an anchor layer between the first polarizing film and the first pressure-sensitive adhesive layer, the anchor layer preferably contains a conductive polymer and preferably has a thickness of 0.01 to 0.5 μm and a surface resistance value of 1.0×10⁸ to 1.0×10¹⁰Ω/□.

The thickness of the anchor layer is preferably from 0.01 to 0.5 μm, more preferably from 0.01 to 0.4 μm, even more preferably from 0.02 to 0.3 μm, from the viewpoints of the stability of the surface resistance value and the adhesiveness to the pressure-sensitive adhesive layer.

The surface resistance value of the anchor layer is preferably 1.0×10⁸ to 1.0×10¹⁰Ω/□, more preferably 1.0×10⁸ to 8.0×10⁹Ω/□, even more preferably 1.0×10⁸ to 6.0×10⁹Ω/□, from the viewpoints of antistatic function and touch sensor sensitivity. In particular, by comprising the anchor layer with conductivity (antistatic property), the antistatic function is more excellent as compared with the case where the pressure-sensitive adhesive layer alone imparts antistatic property, and the antistatic agent used for the pressure-sensitive adhesive layer can be reduced to a small amount, which is a preferred embodiment from the viewpoint of appearance defects such as precipitation/segregation of antistatic agent and white turbidity in a humidified environment as well as from the viewpoint of durability. Further, in the case where a conduction structure is provided on the side surface of the first pressure-sensitive adhesive layer attached polarizing film forming an in-cell type liquid crystal panel, since the anchor layer has conductivity, a contact area with the conduction structure can be secured as an antistatic layer (conductive layer) as compared with the case where the pressure-sensitive adhesive layer alone imparts antistatic property. As a result, an excellent antistatic function is given, which is preferable.

In view of optical characteristics, appearance, antistatic effect, and stability of antistatic effects during heating or humidification, it is preferable to use the conductive polymer. In particular, conductive polymers such as polyaniline and polythiophene are preferably used. Those which are soluble in an organic solvent or water or are dispersible in water can be appropriately used as a conductive polymer, but a water-soluble conductive polymer or a water-dispersible conductive polymer is preferably used. The water-soluble conductive polymer and the water-dispersible conductive polymer can be prepared as an aqueous solution or an aqueous dispersion of a coating liquid for forming the antistatic layer and the coating liquid does not need to use a nonaqueous organic solvent. Thus, deterioration of the optical film substrate due to the organic solvent can be suppressed. The aqueous solution or aqueous dispersion may contain an aqueous solvent in addition to water. For example, it is possible to use alcohols such as methanol, ethanol, n-propanol, isopropanol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol, and cyclohexanol.

In addition, it is preferable that the water-soluble conductive polymer or the water-dispersible conductive polymer such as polyaniline and polythiophene have a hydrophilic functional group in the molecule. Examples of the hydrophilic functional group include a sulfone group, an amino group, an amide group, an imino group, a quaternary ammonium base, a hydroxyl group, a mercapto group, a hydrazino group, a carboxyl group, a sulfate group, a phosphate group, or salts thereof. By having a hydrophilic functional group in the molecule, the conductive polymer is easily dissolved in water or easily dispersed to fine particles in water, thereby to be able to easily prepare the water-soluble conductive polymer or water-dispersible conductive polymer. When a polythiophene polymer is used, polystyrene sulfonic acid is usually used in combination.

Examples of commercially available water-soluble conductive polymers include polyaniline sulfonic acid (weight average molecular weight in terms of polystyrene conversion: 150,000, manufactured by Mitsubishi Rayon Co., Ltd.) and the like. Examples of commercially available water-dispersible conductive polymers include polythiophene-based conductive polymers (trade name: DENATRON series, manufactured by Nagase ChemteX Corporation) and the like.

As a material for forming the anchor layer, a binder component can be added together with the conductive polymer for the purpose of improving the film forming property of a conductive polymer and the adhesiveness to an optical film. In the case where the conductive polymer is an aqueous material such as a water-soluble conductive polymer or a water-dispersible conductive polymer, a water-soluble or water-dispersible binder component is used. Examples of the binder include oxazoline group-containing polymers, polyurethane resins, polyester resins, acrylic resins, polyether resins, cellulose resins, polyvinyl alcohol resins, epoxy resins, polyvinyl pyrrolidone, polystyrene resins, polyethylene glycol, pentaerythritol, and the like. In particular, polyurethane resins, polyester resins and acrylic resins are preferred. One or two or more kinds of these binders can be appropriately used according to the purpose.

It is preferable to control the amount of each of the conductive polymer and the binder to be used so that the surface resistance value of the obtained anchor layer is 1.0×10⁸ to 1.0×10¹⁰Ω/□ depending on the type thereof.

### <Surface Treatment Layer>

The surface treatment layer can be provided on the side where the first pressure-sensitive adhesive layer of the first polarizing film is not provided. The surface treatment layer can be provided on a transparent protective film used for the first polarizing film or provided separately from the transparent protective film. As the surface treatment layer, a hard coat layer, an antiglare treatment layer, an antireflection layer, a sticking prevention layer, and the like can be provided.

The surface treatment layer is preferably a hard coat layer. As a material for forming the hard coat layer, for example, a thermoplastic resin or a material which is cured by heat or radiation can be used. Examples of such materials include thermosetting resins and radiation-curable resins such as ultraviolet curable resins and electron beam curable resins. Among them, ultraviolet curable resins are preferred, which can efficiently form a cured resin layer by a simple processing operation at the time of curing by ultraviolet radiation. Examples of such curable resins include a variety of resins such as polyester resins, acrylic resins, urethane resins, amide resins, silicone resins, epoxy resins, and melamine resins, including monomers, oligomers, and polymers thereof. In particular, radiation curable resins, specifically ultraviolet curable resins are preferred, because of high processing speed and less thermal damage to the substrate. For example, an ultraviolet curable resin having an ultraviolet-polymerizable functional group, particularly having two or more ultraviolet-polymerizable functional groups, specifically including an acrylic monomer or oligomer component with 3 to 6 ultraviolet-polymerizable functional groups is preferably used. The ultraviolet curable resin may be mixed with a photopolymerization initiator.

In addition, as the surface treatment layer, an antiglare treatment layer or an antireflection layer can be provided for the purpose of improving visibility. An antiglare layer and an antireflection layer may be provided on the hard coat layer. The constituent material of the antiglare treatment layer is not particularly limited, and for example, a radiation curable resin, a thermosetting resin, a thermoplastic resin, or the like can be used. As the antireflection layer, titanium oxide, zirconium oxide, silicon oxide, magnesium fluoride or the like is used. Multiple layers can be provided for the antireflection layer. Other examples of the surface treatment layer include a sticking prevention layer and the like.

Conductivity can be imparted to the surface treatment layer by containing an antistatic agent. As the antistatic agent, those exemplified above can be used.

### <Other Layers>

The pressure-sensitive adhesive layer attached polarizing film according to the present invention may be provided with, in addition to each layer described above, on the surface of the first polarizing film on the side where the anchor layer can be provided, an easy adhesion layer or various kinds of easy adhesion treatment such as corona treatment and plasma treatment can be applied.

<In-Cell Type Liquid Crystal Cell and in-Cell Type Liquid Crystal Panel>

Hereinafter, an in-cell type liquid crystal cell B and an in-cell type liquid crystal panel C will be described.

### (In-Cell Type Liquid Crystal Cell B)

As shown in FIGS. 2 to 6, an in-cell type liquid crystal cell B includes a liquid crystal layer 20 containing liquid crystal molecules homogeneously aligned in the absence of an electric field, a first transparent substrate 41 and a second transparent substrate 42 sandwiching the liquid crystal layer 20 from both surfaces. In addition, a touch sensing electrode unit related to a touch sensor and a touch driving function is provided between the first transparent substrate 41 and the second transparent substrate 42.

As shown in FIGS. 2, 3, and 6, the touch sensing electrode unit can be formed by a touch sensor electrode 31 and a touch driving electrode 32. The touch sensor electrode referred to herein means a touch detection (reception) electrode. The touch sensor electrode 31 and the touch driving electrode 32 can be independently formed in various patterns. For example, when the in-cell type liquid crystal cell B is a flat surface, it can be disposed in a pattern intersecting at right angles in a form independently provided in an X axis direction and a Y axis direction, respectively. In FIGS. 2, 3, and 6, the touch sensor electrode 31 is disposed on the side (viewing side) of the first transparent substrate 41 with respect to the touch driving electrode 32, but contrary to the above, the touch driving electrode 32 can be disposed on the side of the first transparent substrate 41 (viewing side) with respect to the touch sensor electrode 31.

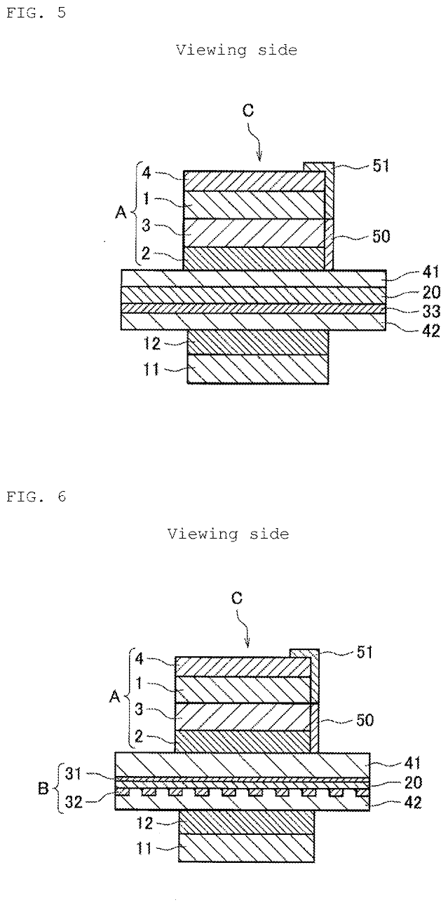

On the other hand, as shown in FIGS. 4 and 5, an electrode 33 integrally formed with the touch sensor electrode and the touch driving electrode can be used in the touch sensing electrode unit.

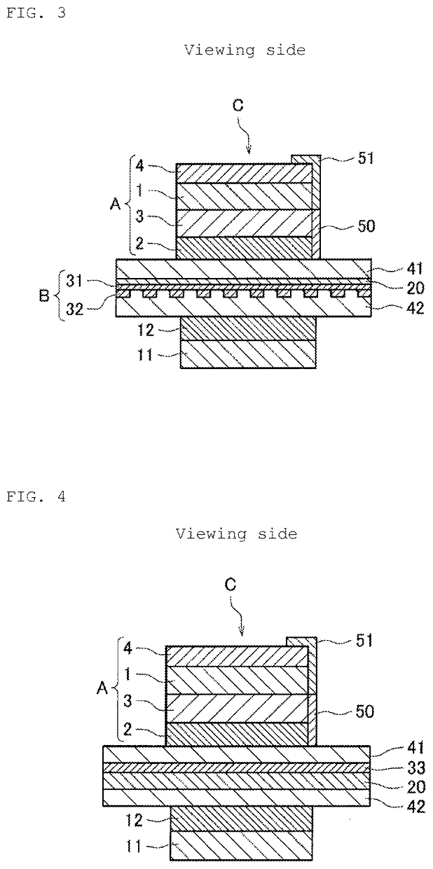

The touch sensing electrode unit may be disposed between the liquid crystal layer 20 and the first transparent substrate 41 or the second transparent substrate 42. FIGS. 2 and 4 show a case where the touch sensing electrode unit is disposed between the liquid crystal layer 20 and the first transparent substrate 41 (on the viewing side of the liquid crystal layer 20). FIGS. 3 and 5 show a case where the touch sensing electrode unit is disposed between the liquid crystal layer 20 and the second transparent substrate 42 (on the backlight side of the liquid crystal layer 20).

As shown in FIG. 6, the touch sensing electrode unit is able to comprise the touch sensor electrode 31 between the liquid crystal layer 20 and the first transparent substrate 41, and comprise the touch driving electrode 32 between the liquid crystal layer 20 and the second transparent substrate 42.

Note that a driving electrode in the touch sensing electrode unit (the touch driving electrode 32, the electrode 33 integrally formed with the touch sensor electrode and the touch driving electrode) can also serve as a common electrode for controlling the liquid crystal layer 20.

As the liquid crystal layer 20 used for the in-cell type liquid crystal cell B, a liquid crystal layer containing liquid crystal molecules homogeneously aligned in the absence of an electric field is used. As the liquid crystal layer 20, for example, an IPS type liquid crystal layer is suitably used. Besides, for the liquid crystal layer 20, for example, any type of liquid crystal layer, such as a TN type, an STN type, a n type, a VA type or the like, can be used. The thickness of the liquid crystal layer 20 is, for example, about 1.5 μm to 4 μm.

As described above, the in-cell type liquid crystal cell B comprises the touch sensing electrode unit related to the touch sensor and the touch driving function in the liquid crystal cell and does not comprise the touch sensor electrode outside the liquid crystal cell. That is, a conductive layer (the surface resistance value is 1×10¹³Ω/□ or less) is not provided on the viewing side (the liquid crystal cell side of the in-cell type liquid crystal panel C with respect to the first pressure-sensitive adhesive layer 2) from the first transparent substrate 41 of the in-cell liquid crystal cell B. Incidentally, in the in-cell type liquid crystal panel C shown in FIGS. 2 to 6, the order of each configuration is shown, but the in-cell type liquid crystal panel C can comprise other configurations as appropriate. A color filter substrate can be provided on the liquid crystal cell (the first transparent substrate 41).

Examples of the material for forming the transparent substrate include glass or polymer film. Examples of the polymer film include polyethylene terephthalate, polycycloolefin, polycarbonate, and the like. When the transparent substrate is formed of glass, its thickness is, for example, about 0.1 mm to 1 mm. When the transparent substrate is formed of a polymer film, its thickness is, for example, about 10 μm to 200 μm. The transparent substrate may comprise an easy adhesion layer or a hard coat layer on its surface.

The touch sensing electrode unit is formed as a transparent conductive layer from the touch sensor electrode 31 (electrostatic capacitance sensor) and the touch driving electrode 32, or from the electrode 33 integrally formed with the touch sensor electrode and the touch driving electrode.

The constituent material of the transparent conductive layer is not particularly limited, and examples thereof include metals such as gold, silver, copper, platinum, palladium, aluminum, nickel, chromium, titanium, iron, cobalt, tin, magnesium, and tungsten, and alloys thereof. Examples of the constituent material of the transparent conductive layer include metal oxides such as oxides of metals (e.g. indium, tin, zinc, gallium, antimony, zirconium, and cadmium), specifically including indium oxide, tin oxide, titanium oxide, cadmium oxide, and a mixture of these metal oxides. Other metal compounds such as copper iodide and the like are used. The metal oxide may further contain an oxide of the metal atom shown in the above group, if necessary. For example, indium oxide (ITO) containing tin oxide, tin oxide containing antimony, etc. are preferably used, and ITO is particularly preferably used. The ITO preferably contains 80 to 99% by weight of indium oxide and 1 to 20% by weight of tin oxide.

The electrode (the touch sensor electrode 31, the touch driving electrode 32, and the electrode 33 formed integrally with the touch sensor electrode and the touch driving electrode) relating to the touch sensing electrode unit can be formed as a transparent electrode pattern usually on the inside of the first transparent substrate 41 and/or the second transparent substrate 42 (on the side of the liquid crystal layer 20 in the in-cell type liquid crystal cell B) by a conventional method. The transparent electrode pattern is usually electrically connected to a routing line (not shown) formed at an end part of the transparent substrate, and the routing line is connected to a controller IC (not shown). The shape of the transparent electrode pattern may be any shape other than a comb shape, such as a stripe shape or a rhombic shape, depending on the application. The height of the transparent electrode pattern is, for example, 10 nm to 100 nm and the width is 0.1 mm to 5 mm.

### (In-Cell Type Liquid Crystal Panel C)

As shown in FIGS. 2 to 6, the in-cell type liquid crystal panel C of the present invention is able to comprise a pressure-sensitive adhesive layer attached polarizing film A on the viewing side of an in-cell type liquid crystal cell B and a second polarizing film 11 on the opposite side thereof. The pressure-sensitive adhesive layer attached polarizing film A is disposed on the side of the first transparent substrate 41 of the in-cell type liquid crystal cell B with the first pressure-sensitive adhesive layer 2 interposed therebetween without a conductive layer interposed therebetween. On the other hand, on the side of the second transparent substrate 42 of the in-cell type liquid crystal cell B, the second polarizing film 11 is disposed with the second pressure-sensitive adhesive layer 12 interposed therebetween. The first polarizing film 1 and the second polarizing film 11 in the pressure-sensitive adhesive layer attached polarizing film A are disposed so that the transmission axes (or absorption axes) of the respective polarizers are orthogonal to each other on both sides of the liquid crystal layer 20.

As the second polarizing film 11, those described for the first polarizing film 1 can be used. The second polarizing film 11 to be used may be the same as or different from the first polarizing film 1.

For forming the second pressure-sensitive adhesive layer 12, the pressure-sensitive adhesive described for the first pressure-sensitive adhesive layer 2 can be used. The pressure-sensitive adhesive used for forming the second pressure-sensitive adhesive layer 12 may be the same as or different from the first pressure-sensitive adhesive layer 2. The thickness of the second pressure-sensitive adhesive layer 12 is not particularly limited, and is, for example, about 1 to 100 μm. Such thickness is preferably 2 to 50 μm, more preferably 2 to 40 μm, and still more preferably 5 to 35 μm.

In the in-cell type liquid crystal panel C, a conduction structure 50 can be provided on the side surfaces of the anchor layer 3 and the first pressure-sensitive adhesive layer 2 of the pressure-sensitive adhesive layer attached polarizing film A. The conduction structure 50 may be provided on the entire side surfaces of the anchor layer 3 and the first pressure-sensitive adhesive layer 2 or may be provided in a part thereof. In the case where the conduction structure is provided in a part, in order to ensure conduction on the side surface, it is preferable that the conduction structure be provided in a proportion of 1 area % or more, preferably 3 area % or more of the area of the side surface. In addition to the above, as shown in FIG. 2, a conduction structure 51 can be provided on the side surface of the first polarizing film 1.

It is possible to suppress the occurrence of static electricity by connecting the potential to the other suitable portion from the side surface of the anchor layer 3 and the first pressure-sensitive adhesive layer 2 by the conduction structure 50. As a material for forming the conduction structures 50 and 51, for example, a conductive paste such as silver paste, gold paste or other metal paste can be mentioned, and other conductive adhesives or any other suitable conductive materials can be used. The conduction structure 50 can also be formed in a linear shape extending from the side surface of the anchor layer 3 and the first pressure-sensitive adhesive layer 2. The conduction structure 51 can also be formed in the same linear shape.

In addition, the first polarizing film 1 disposed on the viewing side of the liquid crystal layer 20, and the second polarizing film 11 disposed on the side opposite to the viewing side of the liquid crystal layer 20 can be used by laminating other optical films, depending on the suitability of each arrangement position. As the other optical film which may be used for forming a liquid crystal display device or the like, there are exemplified those capable of forming an optical film layer, such as a reflection plate, an anti-transmission plate, a retardation film (including wavelength plates such as ½ and ¼), a visual compensation film, and a brightness enhancement film. These can be used in one layer or in two or more layers.

### (Liquid Crystal Display Device)

The liquid crystal display device using the in-cell type liquid crystal panel of the present invention (liquid crystal display device with a built-in touch sensing function) can use appropriately members forming a liquid crystal display device, such as those using backlight or reflection plate for lighting system.

### EXAMPLES

Hereinafter, the present invention will be specifically described by way of working examples thereof. However, the invention is not limited by the examples. In each of the examples, the wording “part (s)” and the symbol “%” represent part(s) by weight and % by weight, respectively. The following “initial value” (room temperature standing condition) is a value in a state left standing at 23° C.×65% RH and the value “after humidification” refers to a value measured after charging in a humidified environment of 60° C.×95% RH for 120 hours and further drying at 40° C. for 1 hour.

### (Preparation of Polarizing Film)

An 80 μm-thick polyvinyl alcohol film was stretched between rolls each having a different speed ratio at a stretching ratio of 3 times, while being dyed in a 0.3% iodine solution at 30° C. for 1 minute. Then, the stretched film was further stretched to attain a total stretching ratio of 6 times while being immersed in an aqueous solution containing 4% of boric acid and 10% of potassium iodide at 60° C. for 0.5 minutes. Subsequently, the stretched film was washed by immersing it in an aqueous solution containing 1.5% of potassium iodide at 30° C. for 10 seconds and then dried at 50° C. for 4 minutes to obtain a 20 μm-thick polarizer. Polarizing films P1 to P5 were prepared by laminating each transparent protective film described below on both surfaces of the polarizer respectively using a polyvinyl alcohol type adhesive. Polarizing films P6 and P7 were prepared by bonding a corona-treated cycloolefin polymer (COP) film on one surface of the polarizer with an ultraviolet curable acrylic adhesive.

Various types of polarizing films (polarizing plates) as shown in Table 1 were prepared by using transparent protective films each having the following moisture permeability.

P1: Cycloolefin polymer (COP) type polarizing film: A 13 μm-thick COP transparent protective film (moisture permeability of 36 g/(m²·24 h), manufactured by Zeon Corporation) was subjected to corona treatment and then used.

P2: Acrylic polarizing film: A 30 μm-thick (meth)acrylic transparent protective film (moisture permeability of 150 g/(m²·24 h)) was subjected to corona treatment and then used.

P3: Triacetyl cellulose film (TAC) type polarizing film: A 40 μm-TAC type transparent protective film (moisture permeability: 850 g/(m²·24 h), manufactured by KONICA Co., Ltd.) was subjected to saponification treatment and then used.

P4: Cycloolefin polymer (COP) type polarizing film: A 50 μm-thick COP type transparent protective film (moisture permeability of 8 g/(m²·24 h), manufactured by Zeon Corporation) was subjected to corona treatment and then used.

P5: TAC type polarizing film: A 25 μm-thick TAC type transparent protective film (moisture permeability of 1000 g/(m²·24 h), manufactured by Fuji Film Co., Ltd.) was subjected to saponification treatment and then used.

P6: COP one-side protected polarizing film (COP type transparent protective film on the pressure-sensitive adhesive layer side); A 13 μm-thick COP type transparent protective film (moisture permeability of 36 g/(m²·24 h), manufactured by Zeon Corporation) was subjected to corona treatment and then used.

P7: COP one-side protected polarizing film (COP type transparent protective film on the viewing side); A 13 μm-thick COP type transparent protective film (moisture permeability of 36 g/(m2·24 h), manufactured by Zeon Corporation) was subjected to corona treatment and then used.

Corona treatment (0.1 kw, 3 m/min, 300 mm width) was performed as an easy adhesion treatment on the pressure-sensitive adhesive layer or the anchor layer-formed surface side of the polarizing film.

### (Preparation of Acrylic Polymer 1)

A monomer mixture containing 99 parts of butyl acrylate (BA) and 1 part of 4-hydroxybutyl acrylate (HBA) was charged into a four-necked flask equipped with a stirring blade, a thermometer, a nitrogen gas inlet tube and a condenser. To 100 parts (solid content) of the monomer mixture, 0.1 parts of 2,2′-azobisisobutyronitrile as a polymerization initiator were charged together with 100 parts of ethyl acetate, and nitrogen gas was introduced thereto with gentle stirring. After purging the inside of the flask with nitrogen gas, a polymerization reaction was carried out for 8 hours while keeping the liquid temperature in the flask at around 55° C. to prepare a solution of acrylic polymer 1.

### (Preparation of Acrylic Polymers 2 and 3)

A solution of each of an acrylic polymer 2 and an acrylic polymer 3 was prepared in the same manner as in the preparation of the acrylic polymer 1, except that a monomer mixture containing butyl acrylate (BA) and 4-hydroxybutyl acrylate (HBA) in an amount shown in Table 1 was charged.

### (Preparation of Acrylic Polymer 4)

A solution of acrylic polymer 4 was prepared in the same manner as in the preparation of the acrylic polymer 1, except that a monomer mixture containing butyl acrylate (BA) and 2-hydroxyethyl acrylate (HEA) in an amount shown in Table 1 was charged.

### (Preparation of Acrylic Polymer 5)

A solution of acrylic polymer 5 was prepared in the same manner as in the preparation of the acrylic polymer 1, except that a monomer mixture containing butyl acrylate (BA) and N-vinyl-2-pyrrolidone (NVP) in an amount shown in Table 1 was charged.

### (Preparation of Acrylic Polymer 6)

A solution of acrylic polymer 6 was prepared in the same manner as in the preparation of the acrylic polymer 1, except that a monomer mixture containing butyl acrylate (BA) and acrylic acid (AA) in an amount shown in Table 1 was charged.

### (Preparation of Acrylic Polymer 7)

A monomer mixture containing 75 parts of butyl acrylate (BA), 21 parts of phenoxyethyl acrylate (PEA), 3.3 parts of N-vinyl-2-pyrrolidone (NVP), 0.3 parts of acrylic acid (AA), and 0.4 parts of 4-hydroxybutyl acrylate (HBA) was charged into a four-necked flask equipped with a stirring blade, a thermometer, a nitrogen gas inlet tube and a condenser. To 100 parts (solid content) of the monomer mixture, 0.1 parts of 2,2′-azobisisobutyronitrile as a polymerization initiator were charged together with 100 parts of ethyl acetate, and nitrogen gas was introduced thereto with gentle stirring. After purging the inside of the flask with nitrogen gas, a polymerization reaction was carried out for 8 hours while keeping the liquid temperature in the flask at around 55° C. to prepare a solution of acrylic polymer 7.

### (Preparation of Pressure-Sensitive Adhesive Composition)

An ionic compound was blended in the amount (solid content, active ingredient) shown in Table 1 with respect to 100 parts of the solid content of the acrylic polymer solution obtained above, and 0.2 parts of an isocyanate crosslinking agent (TAKENATE D 160N, trimethylolpropane hexamethylene diisocyanate, manufactured by Mitsui Chemicals, Inc.), 0.3 parts of benzoyl peroxide (NYPER BMT, manufactured by NOF CORPORATION), and 0.3 parts of a silane coupling agent (X-41-1810, manufactured by Shin-Etsu Chemical Co., Ltd.) were further blended to prepare a solution of acrylic pressure-sensitive adhesive composition used in each of Examples and Comparative Examples.

Abbreviations of ionic compounds described in Table 1 are as follows.

Li-TFSI: Lithium bis(trifluoromethanesulfonyl)imide, manufactured by Mitsubishi Materials Corporation, an inorganic cation-anion salt (alkali metal salt)

MPP-TFSI: Methylpropylpyrrolidinium bis(trifluoromethanesulfonyl)imide, manufactured by Mitsubishi Materials Corporation, an organic cation-anion salt (ionic liquid)

EMI-TFSI: 1-Ethyl-3-methylimidazolium bis(trifluoromethanesulfonyl)imide, manufactured by Dai-ichi Kogyo Seiyaku Co., Ltd., an organic-cation anion salt (ionic liquid)

EMI-FSI: 1-Ethyl-3-methylimidazolium bis(fluorosulfonyl)imide, manufactured by Dai-ichi Kogyo Seiyaku Co., Ltd., an organic cation-anion salt (ionic liquid)

DcPy-FSI: N-Decylpyridinium bis(fluorosulfonyl)imide, manufactured by Mitsubishi Materials Corporation, an organic cation-anion salt (ionic liquid)

### (Formation of Pressure-Sensitive Adhesive Layer)

Next, the solution of the acrylic pressure-sensitive adhesive composition was coated onto one surface of a polyethylene terephthalate (PET) film (separator film; trade name: MRF38, manufactured by Mitsubishi Polyester Film, Inc.) treated with a silicone release agent so that the thickness of the pressure-sensitive adhesive layer after drying was 23 μm, and then dried at 155° C. for 1 minute. In this way, the pressure-sensitive adhesive layer was formed on the surface of the separator film. Next, the pressure-sensitive-adhesive layer formed on the separator film was transferred onto the polarizing film.

### Examples 1 to 19, Comparative Examples 1 to 4, and Reference Example 1

A pressure-sensitive adhesive layer formed from the pressure-sensitive adhesive composition shown in Table 1 was sequentially formed on one surface (corona-treated surface side) of the polarizing film obtained above to prepare a pressure-sensitive adhesive layer attached polarizing film.

In Comparative Examples 1 to 3, those in which the moisture permeability of the transparent protective film was out of the desired range were used. In Comparative Example 4, those in which the surface resistance values on the side of the pressure-sensitive adhesive layer, including the initial value and the value after exposure in a humidified environment were out of the desired range, were used.

The pressure-sensitive adhesive layers and the pressure-sensitive adhesive layer attached polarizing film obtained in the above Examples and Comparative Examples were evaluated as follows. Evaluation results are shown in Table 1 and Table 2.

### <Moisture Permeability of Transparent Protective Film>

The moisture permeability of the transparent protective film was measured according to a moisture permeability test (cup method) according to JIS Z 0208. A transparent protective film cut to a diameter of 60 mm was set in a moisture-permeable cup containing about 15 g of calcium chloride, and put in a constant temperature machine of 40° C.×92% RH, and allowed to stand for 24 hours, the weight increase of calcium chloride after standing for 24 hours was measured to determine a moist permeability (g/(m²·24 h)).

### <Surface Resistance Value (Ω/□): Conductivity>

The separator film was peeled off from the obtained pressure-sensitive adhesive layer attached polarizing film and subsequently the surface resistance value of the surface of the pressure-sensitive adhesive layer was measured (see Table 2).

The measurement was made using a device MCP-HT450 manufactured by Mitsubishi Chemical Analytech Co., Ltd. The surface resistance value on the pressure-sensitive adhesive layer side is a value after measurement for 10 seconds at an applied voltage of 250 V.

The variation ratio (b/a) in Table 2 is a value calculated from the surface resistance value (a) of “initial value” and the surface resistance value (b) of “after humidification” (a value rounded to one decimal place).

### <ESD Test>

In Examples 1 to 19 and Comparative Examples 1 to 4, a separator film was peeled off from a pressure-sensitive adhesive layer attached polarizing film and then the polarizing film was bonded to the viewing side of an in-cell type liquid crystal cell as shown in FIG. 3.

Next, a silver paste having a width of 5 mm was applied to the side surface portion of the polarizing film thus laminated so as to cover each side surface portion of the polarizing film and the pressure-sensitive adhesive layer and connected to a ground electrode from the outside.

In Reference Example 1, a separator film was peeled off from a pressure-sensitive adhesive layer attached polarizing film and then the polarizing film was bonded to the viewing side (sensor layer) of an on-cell type liquid crystal cell.

The liquid crystal display panel was set on a backlight device, and an electrostatic discharge gun was shot onto the polarizing film side on the viewing side at an applied voltage of 9 kV, and the time until the disappearance of white voids due to electricity was measured, and this was judged as “initial value” according to the following criteria. Regarding “after humidification”, as well as “initial value”, judgment was made according to the following criteria. The evaluation result which is a problem in practical use is represented as x.

### (Evaluation Criteria)

⊙: The time until the disappearance of white voids is within 3 seconds.

◯: The time until the disappearance of white voids is more than 3 seconds and within 10 seconds

Δ: The time until the disappearance of white voids is more than 10 seconds and within 60 seconds.

x: The time until the disappearance of white voids is more than 60 seconds.

### <TSP Sensitivity>

In Examples 1 to 19 and Comparative Examples 1 to 4, a lead wiring (not shown) at the peripheral portion of a transparent electrode pattern inside an in-cell type liquid crystal cell was connected to a controller IC (not shown), and in Reference Example 1, a lead wiring at the peripheral portion of a transparent electrode pattern on an on-cell type liquid crystal cell viewing side was connected to a controller IC, thereby to fabricate a liquid crystal display device with built-in touch sensing function. With an input display device of the touch-sensing function built-in liquid crystal display device being used, visual observation was carried out, and this was regarded as “initial value” and the presence or absence of malfunction was confirmed.

◯: No malfunction occurred

x: Malfunction occurred

### <Heat Resistance>

A pressure-sensitive adhesive layer attached polarizing film cut into a 15-inch size was used as a sample. The sample was stuck to a 0.7 mm-thick alkali-free glass (EG-XG, manufactured by Corning Incorporated) using a laminator.

Subsequently, the sample was autoclaved at 50° C. and 0.5 MPa for 15 minutes to completely adhere the sample to an alkali-free glass. The sample subjected to such treatment was treated for 500 hours in an atmosphere at 85° C. and then the appearance between the polarizing film and the alkali-free glass was visually evaluated according to the following criteria. The evaluation result which is a problem in practical use is represented by x.

### (Evaluation Criteria)

◯: No appearance changes such as foaming, peeling or the like occurs.

Δ: Slight peeling or foaming occurs at the end part, causing no problem in practical use

x: Significant peeling or foaming occurs at the end part, causing problems in practical use.

TABLE 1

| | | | | | | | | | Ionic compound | |
|---|---|---|---|---|---|---|---|---|---|---|
| | | | | | | | | | | Blending |
| | | | | | | | | Type of | | amount |
| | Type of | | | | | | | obtained | | (parts |
| | polarizing | | | | | | | acrylic | | by |
| | film | BA | PEA | NVP | HBA | HEA | AA | polymers | Type | weight) |
| Example 1 | P1 | 99 | | | 1 | | | 1 | MPP-TFSI | 3 |
| Example 2 | P1 | 99.9 | | | 0.1 | | | 2 | MPP-TFSI | 3 |
| Example 3 | P1 | 96 | | | 4 | | | 3 | MPP-TFSI | 3 |
| Example 4 | P1 | 99 | | | | 1 | | 4 | MPP-TFSI | 3 |
| Example 5 | P1 | 99 | | 1 | | | | 5 | MPP-TFSI | 3 |
| Example 6 | P1 | 99 | | | | | 1 | 6 | MPP-TFSI | 3 |
| Example 7 | P1 | 75 | 21 | 3.3 | 0.4 | | 0.3 | 7 | MPP-TFSI | 14 |
| Example 8 | P1 | 75 | 21 | 3.3 | 0.4 | | 0.3 | 7 | EMI-TFSI | 14 |
| Example 9 | P1 | 75 | 21 | 3.3 | 0.4 | | 0.3 | 7 | EMI-FSI | 10 |
| Example 10 | P1 | 75 | 21 | 3.3 | 0.4 | | 0.3 | 7 | DcPy-FSI | 10 |
| Example 11 | P1 | 75 | 21 | 3.3 | 0.4 | | 0.3 | 7 | Li-TFSI | 10 |
| Example 12 | P2 | 75 | 21 | 3.3 | 0.4 | | 0.3 | 7 | MPP-TFSI | 14 |
| Example 13 | P2 | 75 | 21 | 3.3 | 0.4 | | 0.3 | 7 | EMI-TFSI | 14 |
| Example 14 | P2 | 75 | 21 | 3.3 | 0.4 | | 0.3 | 7 | EMI-FSI | 10 |
| Example 15 | P2 | 75 | 21 | 3.3 | 0.4 | | 0.3 | 7 | Li-TFSI | 10 |
| Example 16 | P3 | 75 | 21 | 3.3 | 0.4 | | 0.3 | 7 | Li-TFSI | 10 |
| Example 17 | P4 | 75 | 21 | 3.3 | 0.4 | | 0.3 | 7 | MPP-TFSI | 14 |
| Example 18 | P6 | 75 | 21 | 3.3 | 0.4 | | 0.3 | 7 | MPP-TFSI | 14 |
| Example 19 | P7 | 75 | 21 | 3.3 | 0.4 | | 0.3 | 7 | MPP-TFSI | 14 |
| Comparative | P5 | 75 | 21 | 3.3 | 0.4 | | 0.3 | 7 | MPP-TFSI | 7 |
| example 1 | | | | | | | | | | |
| Comparative | P5 | 75 | 21 | 3.3 | 0.4 | | 0.3 | 7 | EMI-TFSI | 7 |
| example 2 | | | | | | | | | | |
| Comparative | P5 | 75 | 21 | 3.3 | 0.4 | | 0.3 | 7 | EMI-FSI | 7 |
| example 3 | | | | | | | | | | |
| Comparative | P1 | 75 | 21 | 3.3 | 0.4 | | 0.3 | 7 | Li-TFSI | 40 |
| example 4 | | | | | | | | | | |
| Reference | P1 | 75 | 21 | 3.3 | 0.4 | | 0 .3 | 7 | Li-TFSI | 12 |
| example 1 | | | | | | | | | | |

TABLE 2

| | | Surface resistance value of | | | | | | |
|---|---|---|---|---|---|---|---|---|
| | | pressure-sensitive adhesive | | | | | | |
| | | layer (Ω/▭) | | | | ESD evaluation | | |
| | | | After | | | | After | |
| | | | humidification | | | | humidification | |
| | | | of | | | | of | Heat |
| | Type of | Initial | 60° C. × 95% | Variation | TSP | | 60° C. × 95% | resistance |
| | evaluation | value | RH | ratio | sensitivity | Initial | RH | 85° C. |
| | panel | (a) | 120 h (b) | (b/a) | malfunction | value | 120 h | 500 h |
| Example 1 | IN-CELL | 8.9E+09 | 7.8E+09 | 0.9 | ◯ | ◯ | ◯ | ◯ |
| Example 2 | IN-CELL | 1.1E+10 | 1.8E+10 | 1.6 | ◯ | Δ | Δ | ◯ |
| Example 3 | IN-CELL | 8.0E+09 | 6.4E+09 | 0.8 | ◯ | ◯ | ◯ | ◯ |
| Example 4 | IN-CELL | 8.3E+09 | 7.8E+09 | 0.9 | ◯ | ◯ | ◯ | ◯ |
| Example 5 | IN-CELL | 9.4E+09 | 1.9E+10 | 2.0 | ◯ | ◯ | Δ | ◯ |
| Example 6 | IN-CELL | 9.5E+09 | 1.6E+10 | 1.7 | ◯ | ◯ | Δ | ◯ |
| Example 7 | IN-CELL | 7.6E+08 | 8.4E+08 | 1.1 | ◯ | ⊚ | ⊚ | ◯ |
| Example 8 | IN-CELL | 4.7E+08 | 3.9E+08 | 0.8 | ◯ | ⊚ | ⊚ | ◯ |
| Example 9 | IN-CELL | 4.5E+08 | 4.4E+08 | 1.0 | ◯ | ⊚ | ⊚ | ◯ |
| Example 10 | IN-CELL | 1.3E+09 | 2.0E+09 | 1.5 | ◯ | ⊚ | ⊚ | ◯ |
| Example 11 | IN-CELL | 1.9E+09 | 2.2E+09 | 1.1 | ◯ | ⊚ | ⊚ | ◯ |
| Example 12 | IN-CELL | 7.6E+08 | 5.2E+09 | 6.9 | ◯ | ⊚ | ◯ | ◯ |
| Example 13 | IN-CELL | 4.7E+08 | 6.6E+09 | 14.1 | ◯ | ⊚ | ◯ | ◯ |
| Example 14 | IN-CELL | 4.5E+08 | 9.1E+09 | 20.1 | ◯ | ⊚ | ◯ | ◯ |
| Example 15 | IN-CELL | 1.9E+09 | 3.4E+09 | 1.8 | ◯ | ⊚ | ◯ | ◯ |
| Example 16 | IN-CELL | 1.9E+09 | 1.1E+10 | 5.7 | ◯ | ⊚ | Δ | ◯ |
| Example 17 | IN-CELL | 7.6E+08 | 7.4E+08 | 1.0 | ◯ | ⊚ | ⊚ | Δ |
| Example 18 | IN-CELL | 7.6E+08 | 8.7E+08 | 1.1 | ◯ | ⊚ | ⊚ | ◯ |
| Example 19 | IN-CELL | 8.7E+08 | 1.7E+09 | 1.9 | ◯ | ⊚ | ⊚ | ◯ |
| Comparative example 1 | IN-CELL | 5.5E+09 | 2.2E+11 | 40.4 | ◯ | ◯ | X | ◯ |
| Comparative example 2 | IN-CELL | 3.2E+09 | 2.3E+11 | 71.6 | ◯ | ◯ | X | ◯ |
| Comparative example 3 | IN-CELL | 1.0E+09 | 1.9E+11 | 187.2 | ◯ | ⊚ | X | ◯ |
| Comparative example 4 | IN-CELL | 9.1E+07 | 9.8E+07 | 1.1 | X | ⊚ | ⊚ | X |
| Reference example 1 | ON-CELL | 1.6E+09 | 2.5E+09 | 1.6 | X | ⊚ | ⊚ | ◯ |

From the evaluation results in Table 2, it was confirmed that the heat resistance, antistatic property, suppression of static electricity unevenness, and touch sensor sensitivity are at practical level in all the Examples. On the other hand, in Comparative Examples 1 to 3, it was confirmed that since the transparent protective film having a moisture permeability outside the desired range was used, the variation in the surface resistance value in the humidified environment was large and the surface resistance value on the pressure-sensitive adhesive layer side was outside the preferable range, so that static electricity unevenness occurred and it took time to disappear white voids due to poor conduction. In Comparative Example 4, since the surface resistance value on the pressure-sensitive adhesive layer side was outside the preferable range, malfunction was confirmed in the state where the input display device of the touch-sensing function built-in liquid crystal display device was used, and it was also confirmed that the heat resistance was poor. In Reference Example 1, reduction in touch sensor sensitivity was confirmed when applied to an on-cell type liquid crystal cell.

### DESCRIPTION OF REFERENCE SIGNS

A Adhesive layer attached Polarizing film
B In-cell type liquid crystal cell
C In-cell type liquid crystal panel
1, 11 First and second polarizing films
2, 12 First and second pressure-sensitive adhesive layers
3 Anchor layer
4 Surface treatment layer
20 Liquid crystal layer
31 Touch sensor electrode
32 Touch driving electrode
33 Touch driving electrode and sensor electrode
41, 42 First and second transparent substrates

1. A pressure-sensitive adhesive layer attached polarizing film, comprising a pressure-sensitive adhesive layer and a polarizing film,
wherein the polarizing film includes at least a polarizer and a transparent protective film;
at least the polarizing film and the pressure-sensitive adhesive layer are provided in this order from a viewing side;
the pressure-sensitive adhesive layer includes an antistatic agent;
a surface resistance value of the pressure-sensitive adhesive layer side is 1.0×10⁸ to 1.0×10¹¹Ω/□ at the time of producing the pressure-sensitive adhesive layer attached polarizing film in a state where the pressure-sensitive adhesive layer is provided on the polarizing film and a separator is provided on the pressure-sensitive adhesive layer, and peeling off the separator immediately after the production; and
a moisture permeability of the transparent protective film at 40° C.×92% RH is 900 g/(m²·24 h) or less.

2. The pressure-sensitive adhesive layer attached polarizing film according to claim 1, wherein the antistatic agent is an ionic compound containing a fluorine-containing anion.

3. The pressure-sensitive adhesive layer attached polarizing film according to claim 1, wherein the surface resistance value on the pressure-sensitive adhesive layer side is 1.0×10⁸ to 2.0×10¹⁰Ω/□, and the moisture permeability of the transparent protective film at 40° C.×92% RH is 100 g/(m²·24 h) or less.

4. The pressure-sensitive adhesive layer attached polarizing film according to claim 1, wherein the moisture permeability of the transparent protective film at 40° C.×92% RH is 10 g/(m²·24 h) or more.

5. A pressure-sensitive adhesive layer attached polarizing film, which is used for an in-cell type liquid crystal panel comprising an in-cell type liquid crystal cell including a liquid crystal layer containing liquid crystal molecules homogeneously aligned in the absence of an electric field, a first transparent substrate and a second transparent substrate sandwiching the liquid crystal layer from both surfaces, and a touch sensing electrode unit related to a touch sensor and a touch driving function disposed between the first transparent substrate and the second transparent substrate, wherein:
the pressure-sensitive adhesive layer attached polarizing film is disposed on a viewing side of the in-cell type liquid crystal cell,
a pressure-sensitive adhesive layer of the pressure-sensitive adhesive layer attached polarizing film is disposed between a polarizing film of the pressure-sensitive adhesive layer attached polarizing film and the in-cell type liquid crystal cell,
the polarizing film includes at least a polarizer and a transparent protective film,
at least the polarizing film and the pressure-sensitive adhesive layer are provided in this order from the viewing side,
the pressure-sensitive adhesive layer includes an antistatic agent,
a surface resistance value of the pressure-sensitive adhesive layer side is 1.0×10⁸ to 1.0×10¹¹Ω/□ at the time of producing the pressure-sensitive adhesive layer attached polarizing film in a state where the pressure-sensitive adhesive layer is provided on the polarizing film and a separator is provided on the pressure-sensitive adhesive layer, and peeling off the separator immediately after the production, and
a moisture permeability of the transparent protective film at 40° C.×92% RH is 900 g/(m²·24 h) or less.

6. The pressure-sensitive adhesive layer attached polarizing film used for an in-cell type liquid crystal panel according to claim 5, wherein the antistatic agent is an ionic compound containing a fluorine-containing anion.

7. The pressure-sensitive adhesive layer attached polarizing film used for an in-cell type liquid crystal panel according to claim 5, wherein the surface resistance value of the pressure-sensitive adhesive layer side is 1.0×10⁸ to 2.0×10¹⁰Ω/□, and the moisture permeability of the transparent protective film at 40° C.×92% RH is 100 g/(m²·24 h) or less.

8. The pressure-sensitive adhesive layer attached polarizing film used for an in-cell type liquid crystal panel according to claim 5, wherein the moisture permeability of the transparent protective film at 40° C.×92% RH is 10 g/(m²·24 h) or more.

9. An in-cell type liquid crystal panel, comprising:
an in-cell type liquid crystal cell including a liquid crystal layer containing liquid crystal molecules homogeneously aligned in the absence of an electric field, a first transparent substrate and a second transparent substrate sandwiching the liquid crystal layer from both surfaces, and a touch sensing electrode unit related to a touch sensor and a touch driving function disposed between the first transparent substrate and the second transparent substrate, and
a first polarizing film disposed on a viewing side of the in-cell liquid crystal cell, a second polarizing film disposed on a side opposite to the viewing side, and a first pressure-sensitive adhesive layer disposed between the first polarizing film and the in-cell type liquid crystal cell, wherein:
the first polarizing film includes at least a polarizer and a transparent protective film,
at least the first polarizing film and the first pressure-sensitive adhesive layer are provided in this order from the viewing side,
the first pressure-sensitive adhesive layer includes an antistatic agent,
a surface resistance value of the first pressure-sensitive adhesive layer side is 1.0×10⁸ to 1.0×10¹¹Ω/□ at the time of producing a first pressure-sensitive adhesive layer attached polarizing film in a state where the first pressure-sensitive adhesive layer is provided on the first polarizing film and a separator is provided on the first pressure-sensitive adhesive layer, and peeling off the separator immediately after the production, and
a moisture permeability of the transparent protective film at 40° C.×92% RH is 900 g/(m²·24 h) or less.

10. The in-cell type liquid crystal panel according to claim 9, wherein the antistatic agent is an ionic compound containing a fluorine-containing anion.

11. The in-cell type liquid crystal panel according to claim 9, wherein the surface resistance value of the first pressure-sensitive adhesive layer side is 1.0×10⁸ to 2.0×10¹⁰ and the moisture permeability of the transparent protective film at 40° C.×92% RH is 100 g/(m²·24 h) or less.

12. The in-cell type liquid crystal panel according to claim 9, wherein the moisture permeability of the transparent protective film at 40° C.×92% RH is 10 g/(m²·24 h) or more.

13. A liquid crystal display device comprising the in-cell type liquid crystal panel according to claim 9.
